(19) United States
(12) Patent Application Publication
(10) Pub. No.: US 2020/0082303 A1
(43) Pub. Date: Mar. 12, 2020

(54) VEHICLE ALLOCATION METHOD, SERVER, AND SYSTEM

(71) Applicants: HYUNDAI MOTOR COMPANY, Seoul (KR); KIA MOTORS CORPORATION, Seoul (KR)

(72) Inventor: Jin KIM, Suwon-si (KR)

(73) Assignees: HYUNDAI MOTOR COMPANY, Seoul (KR); KIA MOTORS CORPORATION, Seoul (KR)

(21) Appl. No.: 16/213,006

(22) Filed: Dec. 7, 2018

(30) Foreign Application Priority Data
Sep. 11, 2018 (KR) 10-2018-0108563

(51) Int. Cl. G06Q 10/02; G06Q 50/30; G08G 1/00; G01C 21/34

(52) U.S. Cl. CPC G06Q 10/02; G06Q 50/30; G01C 21/3438; G01C 21/3469; G08G 1/202

(57) ABSTRACT

A vehicle allocation method for allocating autonomous vehicles is provided. The vehicle allocation method includes receiving a vehicle allocation request including a starting point and a destination from a user device; calculating energy consumption of each of a plurality of vehicles to travel a distance from a current location to the starting point, the destination, and a charging station, in response to the vehicle allocation request; selecting a vehicle having the minimum energy consumption among the plurality of vehicles; and sending a driving command for the selected vehicle to travel to the starting point.

### CROSS-REFERENCE TO RELATED APPLICATION

The present application claims priority to and the benefit of Korean Patent Application No. 10-2018-0108563 filed on Sep. 11, 2018, which is incorporated herein by reference in its entirety.

### TECHNICAL FIELD

The present disclosure relates to a vehicle allocation method, server, and system, and more particularly, to a vehicle allocation method, server, and system for allocating autonomous vehicles.

### BACKGROUND

The statement in this section merely provide background information related to the present disclosure and may not constitute prior art.

Vehicles are transportation means running on the roads or tracks with fossil fuel, electricity, etc., as a power source.

Studies about autonomous vehicles are ongoing these days. The autonomous vehicles refer to vehicles that drive on their own without intervention of the driver or passenger.

The autonomous vehicles are used for various purposes. For example, they may be used to enhance safety or fuel efficiency of vehicle, ease traffic jams on the entire road by operating the road only with the autonomous vehicles, and provide transportation means for the mobility handicapped.

Since there is no human intervention in driving from the nature of the autonomous vehicle, the driver can take a nap, do a personal business, or watch a movie during the time for which the driver might otherwise be driving the vehicle by himself/herself. Changes in vehicle usage patterns may increase not only the electric energy consumed by the autonomous driving system itself but also the energy of the vehicle consumed by the individual users, which may have an influence on the vehicle.

For example, people in the vehicle may turn on an indoor lamp that has barely been turned on to do a personal business or have a conference, or play a multimedia system to see a movie, or use a personal laptop to play a game. Like this, people consume electricity of the vehicle, and this leads to a decrease in energy to be used to drive the vehicle and also to shortening of the driving range of the vehicle.

Unmanned taxis or car hailing vehicles in particular, which target unspecified many people, may have different energy use patterns due to, for example, the people's (or passengers') different preferences on air conditioning levels. Accordingly, the unmanned taxis or car hailing vehicles may have problems with optimization efficiency and operation expense of traveling and time required for energy charging of the vehicle.

### SUMMARY

The present disclosure provides a method, server, and system for allocating autonomous vehicles by reflecting energy use characteristics of each person for efficient management and operation of shared vehicles, such as unmanned taxis with an autonomous driving system applied thereto.

In accordance with an aspect of the present disclosure, a vehicle allocation method is provided. The vehicle allocation method includes receiving a vehicle allocation request including a starting point and a destination from a user device; calculating energy consumption of each of a plurality of vehicles to travel a distance from a current location to the starting point, the destination, and a charging station, in response to the vehicle allocation request; selecting a vehicle having the minimum energy consumption among the plurality of vehicles; and sending a driving command for the selected vehicle to travel to the starting point.

Thee calculating energy consumption of each of a plurality of vehicles may include updating a map; and calculating average driving speed and average driving time on each road included in the map based on traffic information received from a traffic information server.

The calculating energy consumption of each of a plurality of vehicles may include obtaining vehicle information including a current location of the vehicle, energy reserve of the vehicle, and power consumption per temperature and driving speed of the vehicle.

The calculating energy consumption of each of a plurality of vehicles may include obtaining user information including power consumption of a user per temperature and time zone.

The calculating energy consumption of each of a plurality of vehicles may include calculating energy consumption of each of the plurality of vehicles by multiplying a combination of the power consumption per temperature and driving speed and the power consumption per temperature and time zone with the distance.

The vehicle allocation request may further include weight of baggage, and the vehicle allocation method may further include adjusting energy reserve of the selected vehicle based on the weight of the baggage.

The vehicle allocation method may further include, when the energy reserve of the selected vehicle is smaller than energy consumption for the distance, selecting a vehicle with the second least energy consumption among the plurality of vehicles.

In accordance with another aspect of the present disclosure, a vehicle allocation server is provided. The vehicle allocation server includes a communication device configured to receive a vehicle allocation request including a starting point and a destination from a user device; and a vehicle allocator configured to calculate energy consumption of each of a plurality of vehicles to travel a distance from a current location to the starting point, the destination, and a charging station, in response to the vehicle allocation request, and select a vehicle having the minimum energy consumption among the plurality of vehicles, wherein the communication device is configured to send a driving command for the selected vehicle to travel to the starting point.

The vehicle allocation server may further include a traffic information manager configured to update a map, calculate average driving speed and average driving time on each road included in the map based on traffic information received from a traffic information server.

The vehicle allocation server may further include a vehicle information manager configured to obtain vehicle information including a current location of the vehicle, energy reserve of the vehicle, and power consumption per temperature and driving speed of the vehicle.

The vehicle allocation server may further include a user information manager configured to obtain user information including power consumption of a user per temperature and time zone.

The vehicle allocator may be configured to calculate energy consumption of each of the plurality of vehicles by multiplying a combination of the power consumption per temperature and driving speed and the power consumption per temperature and time zone with the distance.

The vehicle allocation request may further include weight of baggage, and the vehicle allocation server may further include a vehicle information manager configured to adjust energy reserve of the selected vehicle based on the weight of the baggage.

The vehicle allocator may be configured to, when the energy reserve of the selected vehicle is smaller than energy consumption for the distance, select a vehicle with the second least energy consumption among the plurality of vehicles.

In accordance with another aspect of the present disclosure, a vehicle allocation system is provided. The vehicle allocation system includes a plurality of vehicles; a user device configured to receive a vehicle allocation request including a starting point and a destination from a user; and a vehicle allocation server configured to calculate energy consumption of each of a plurality of vehicles to travel a distance from a current location to the starting point, the destination, and a charging station, in response to the vehicle allocation request, and select a vehicle having the minimum energy consumption among the plurality of vehicles, wherein the selected vehicle is configured to move to the starting point in response to a driving command of the vehicle allocation server.

The vehicle allocation server may update a map, calculate average driving speed and average driving time on each road included in the map based on traffic information received from a traffic information server.

The vehicle allocation server may obtain vehicle information including a current location of the vehicle, energy reserve of the vehicle, and power consumption per temperature and driving speed of the vehicle.

The vehicle allocation server may obtain user information including power consumption of user per temperature and time zone.

The vehicle allocation server may calculate energy consumption of each of the plurality of vehicles by multiplying a combination of the power consumption per temperature and driving speed and the power consumption per temperature and time zone with the distance.

The vehicle allocation server may, when the energy reserve of the selected vehicle is smaller than energy consumption for the distance, select a vehicle with the second least energy consumption among the plurality of vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a vehicle allocation system, in one form of the present disclosure;

FIG. 2 shows a configuration of a vehicle included in a vehicle allocation system, in one form of the present disclosure;

FIG. 3 shows a configuration of a vehicle allocation server included in a vehicle allocation system, in one form of the present disclosure;

FIG. 4 shows an example of map information stored in a vehicle allocation server, in one form of the present disclosure;

FIG. 5 shows an example of road information and traffic information stored in a vehicle allocation server, in one form of the present disclosure;

FIG. 6 shows an example of vehicle information stored in a vehicle allocation server, in one form of the present disclosure;

FIG. 7 shows an example of user energy information stored in a vehicle allocation server, in one form of the present disclosure;

FIG. 8 shows an example of a vehicle allocation request sent to a vehicle allocation server, in one form of the present disclosure;

FIGS. 9A and 9B show traveling paths of vehicles according to a vehicle allocation request sent to a vehicle allocation server, in one form of the present disclosure;

FIG. 10 shows optimal driving expenses of vehicles according to a vehicle allocation request sent to a vehicle allocation server, in one form of the present disclosure;

FIG. 11 is a flowchart illustrating information management method of a vehicle allocation server, in one form of the present disclosure; and

FIG. 12 is a flowchart illustrating a vehicle allocation method, in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The principle and forms of the present disclosure will now be described with reference to accompanying drawings.

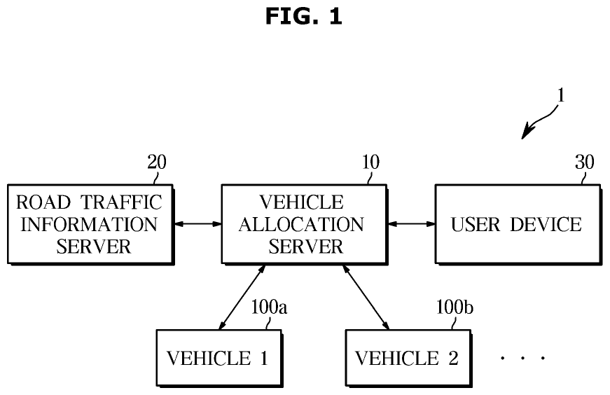

FIG. 1 shows a vehicle allocation system, in one form of the present disclosure.

Referring to FIG. 1, a vehicle allocation system 1 may include a vehicle allocation server 10, a traffic information server 20, a user device 30, and a plurality of vehicles 100a and 100b.

The vehicle allocation server 10 may allocate one of the plurality of vehicles 100a and 100b to a user based on a vehicle allocation request made by the user, traffic information, and information about the plurality of vehicles 100a and 100b.

For example, the vehicle allocation server 10 may receive traffic information of each road from the traffic information server 20, and store a traffic information table including the traffic information of each road.

The vehicle allocation server 10 may receive information about a position and energy of each vehicle (100a, 100b) from the vehicle 100a, 100b, and store vehicle information table including the information about a position and energy of each of the vehicles 100a and 100b.

The vehicle allocation server 10 may receive personal information of passenger(s) including the user (e.g., information about identification of the user, age of the user, weight of the user, etc.) and information about baggage of the user (e.g., weight of the baggage) from the user device 30. The vehicle allocation server 10 may store user information table including the personal information of the passenger, the baggage information of the passenger, and information about energy consumed by the user on board.

Furthermore, the vehicle allocation server 10 may receive the vehicle allocation request from the user device 30, and allocate one of the plurality of vehicles 100a and 100b to the user based on the traffic information table, the vehicle information table, and the user information table.

The traffic information server 20 may collect traffic information of a plurality of roads, and send the collected traffic information to the vehicle allocation server 10.

For example, the traffic information server 20 may receive position and driving information of vehicle (e.g., driving speed) from the vehicles running on the plurality of roads, or receive driving information of vehicles running on a plurality of roads (e.g., driving speed) from cameras installed at the plurality of roads.

The traffic information server 20 may create traffic information of each of the plurality of roads based on the collected driving information of the vehicles. Furthermore, the traffic information server 20 may send the created traffic information to the vehicle allocation server 10.

The user device 30 may receive user inputs from the user (or passenger) and send a vehicle allocation request to the vehicle allocation server 10 in response to the user input.

For example, the user may input identification information of the user, information about the number and ages of passengers (e.g., whether they are adults or children), and information about the baggage (e.g., the total weight of the baggage).

The user device 30 may send the information about the passengers and baggage input from the user to the vehicle allocation server 10.

The user device 30 may include every possible means to receive a user input from the user (or passenger) and send the information about the user input to the vehicle allocation server 10.

For example, the user device 30 may be a personal terminal carried or owned by the user (or passenger). The user device 30 may include a handy terminal, a multimedia terminal, a personal digital assistant (PDA), a tablet computer, a laptop computer, a desktop computer, etc.

The plurality of vehicles 100a and 100b may drive themselves to run or stand (or stop) on the road without manipulation of the driver or passenger.

To drive on their own, the plurality of vehicles 100a and 100b may include a plurality of sensors for collecting surrounding information of the vehicle, and a program and processor for processing the information collected by the plurality of sensors and controlling driving of the vehicle.

The plurality of vehicles 100a and 100b may send driving information of the vehicle (e.g., information about driving position and driving speed) to the traffic information server 20 while driving.

The plurality of vehicles 100a and 100b may each move to a starting point designated by the user in response to vehicle allocation of the vehicle allocation system 1. The vehicle may move to the user-designated destination after the user gets on the vehicle.

Furthermore, the plurality of vehicles 100a and 100b may monitor a remaining amount of energy (e.g., a battery charge level or a remaining amount of fuel) while driving, and move to a charging station or gas station in response to a remaining amount of energy being less than a threshold.

As described above, the vehicle allocation system 1 may allocate one of the plurality of vehicles 100a and 100b to a user based on traffic information of the road and driving states of the vehicles 100a and 100b in response to the vehicle allocation request from the user. The allocated vehicle may carry the user and drive from the starting point to a destination.

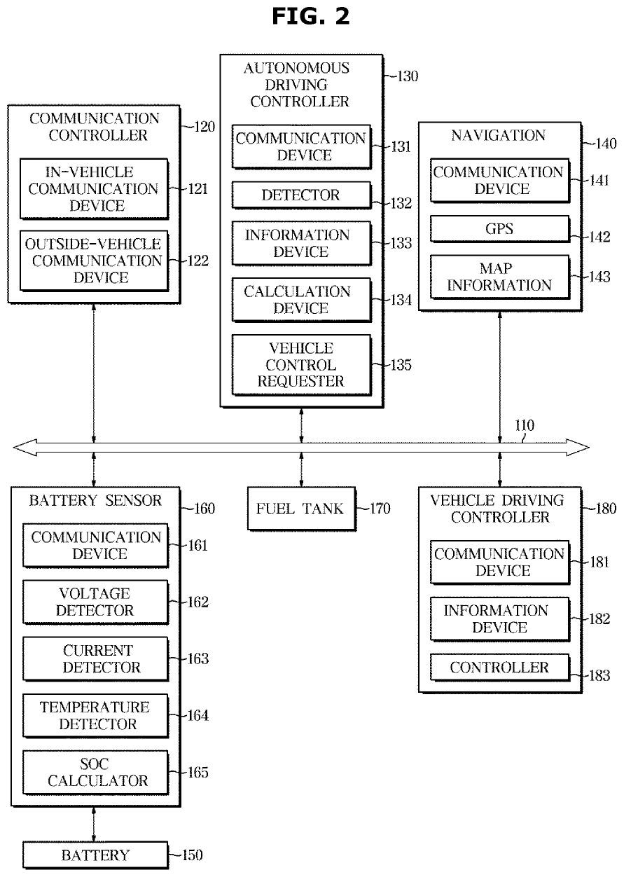

FIG. 2 shows a configuration of a vehicle included in a vehicle allocation system, in one form of the present disclosure.

A vehicle 100 may transport passenger(s) and baggage. Especially, the vehicle 100 may drive themselves to run or stand (or stop) on the road without manipulation of the driver or passenger.

Referring to FIG. 2, the vehicle 100 may include a vehicle communication network 110, a communication controller 120, an autonomous driving controller 130, a navigation 140, a battery 150, a battery sensor 160, a fuel tank 170, and a vehicle driving controller 180.

The vehicle communication network 110 may act as a passage to communicate data between various electronic parts of the vehicle 100.

The vehicle communication network 110 may employ various communication schemes, such as Ethernet, Media Oriented Systems Transport (MOST), Flexray, Controller Area Network (CAN), Local Interconnect Network (LIN), etc.

The vehicle communication network 110 may include heterogeneous networks that employ different communication schemes, and include a gateway between the heterogeneous networks. The gateway may be arranged separately, or incorporated in another device.

The vehicle communication network 110 may also include direct communication between the electronic parts of the vehicle 100 through hard wire.

The communication controller 120 may send information received from the external vehicle allocation server 10 over a wireless network to controllers inside the vehicle. The communication controller 120 may receive infrastructure information, such as vehicle to everything (V2X) required for autonomous driving. Furthermore, the communication controller 120 may send the vehicle information of the vehicle 100 to the vehicle allocation server 10 or the driving information of the vehicle 100 to the traffic information server 20.

The communication controller 120 may include an in-vehicle communication device 121 and an outside-vehicle communication device 122.

The in-vehicle communication device 121 may communicate with various electronic devices inside the vehicle 100 through the vehicle communication network 110. For example, the in-vehicle communication device 121 may exchange data with many different electronic devices inside the vehicle 100 through Ethernet, MOST, Flexray, CAN, LIN and/or the like.

The outside-vehicle communication device 122 may communicate with the vehicle allocation server 10 through a wireless base station. For example, the outside-vehicle communication device 122 may employ a second generation (2G) communication scheme, such as Time Division Multiple Access (TDMA), Code Division Multiple Access (CDMA), etc., a third generation (3G) communication scheme, such as Wide Code Division Multiple Access (WCDMA), Code Division Multiple Access 2000 (CDMA2000), Wireless Broadband (Wibro), World Interoperability for Microwave Access (WiMAX), etc., and a fourth generation (4G) communication scheme, such as Long Term Evolution (LTE), Wireless Broadband Evolution (Wibro Evolution), etc. In addition, the outside-vehicle communication device 122 may employ a fifth generation (5G) communication scheme.

The autonomous driving controller 130 may create driving control signals for the vehicle 100 to autonomously drive itself in response to surrounding conditions of the vehicle 100.

The autonomous driving controller 130 may be separately provided as shown in FIG. 2, or may be included in the vehicle driving controller 180, or may be incorporated with other controller, such as the vehicle driving controller 180.

The autonomous driving controller 130 may receive vehicle allocation information from the vehicle allocation server 10 by communication inside or outside the vehicle 100 and control the vehicle driving controller 180 to make the vehicle 100 autonomously drive to a starting point and destination designated by the user.

The autonomous driving controller 130 may include a communication device 131, a detector 132, an information device 133, a calculation device 134, and a vehicle control requester 135.

The communication device 131 may communicate with various electronic devices inside the vehicle 100 through the vehicle communication network 110. For example, the communication device 131 may receive information about transportation infrastructure and/or traffic information received from other vehicle through the communication controller 120.

Especially, the communication device 131 may receive vehicle allocation information from the vehicle allocation server 10 through the communication controller 120. Furthermore, the communication device 131 may send the vehicle driving controller 180 a driving control signal for the autonomous driving controller 130 to control the vehicle 100.

The detector 132 may collect information required for autonomous driving from the vehicle 100.

For example, the detector 132 may detect lanes and obstacles on the road on which the vehicle 100 is running. The obstacles may include other vehicles, pedestrians, bicycles, animals, and the like.

The detector 132 may include a camera for capturing two dimensional (2D) image of the surroundings of the vehicle 100, a radar for detecting obstacles around the vehicle 100, or a light detection and ranging (Lidar) for acquiring three dimensional images of the surroundings of the vehicle 100.

The information device 133 may store and/or manage information required for autonomous driving.

For example, the information device 133 may store and/or manage information about transportation infrastructure received through the communication device 131, traffic information received from other vehicle, and/or information about surrounding environments of the vehicle 100 detected by the detector 132. The information device 133 may also store and/or manage information about the starting point and destination received from the vehicle allocation server 10.

The calculation device 134 may perform calculation for autonomous driving based on the information required for autonomous driving.

For example, the calculation device 134 may calculate a route from a starting point to a destination based on the information about the starting point and destination received from the vehicle allocation server 10, information about transportation infrastructure, and/or traffic information received from other vehicle. Furthermore, the calculation device 134 may calculate a detour route to avoid an obstacle detected by the detector 132.

The vehicle control requester 135 may create a driving control signal to drive along the route calculated by the calculation device 134. The driving control signal created by the vehicle control requester 135 may be sent to the vehicle driving controller 180 through the communication device 131.

The navigation 140 may store map information and display a route to a destination on the map. The navigation 140 may include a communication device 141, a global positioning system (GPS) module 142, and map information 143.

The communication device 141 may communicate with various electronic devices inside the vehicle 100 through the vehicle communication network 110 (e.g., Ethernet, MOST, Flexray, CAN, LIN, etc.).

The GPS module 142 may receive signal transmission time stamps and GPS satellite position information from a plurality of GPS satellites, and may then calculate a location of the vehicle 100 based on the signal transmission time stamps and GPS satellite position information received from the plurality of GPS satellites.

The map information 143 may store a map for the navigation 140 to give directions to the driver and information relating to roads included in the map displayed by the navigation 140 to give directions to the driver.

The battery 150 may store electricity supplied from an alternator or an external charging device and supply the electric power to the electronic parts included in the vehicle 100. For example, the battery 150 may include a lead-acid battery or lithium-ion battery.

The battery sensor 160 may obtain state information relating to the battery 150. The battery sensor 160 may include a communication device 161 for communicating various electronic devices inside the vehicle 100 over the vehicle communication network 110, a voltage detector 162 for measuring output voltage of the battery 150, a current detector 163 for measuring input/output current, a temperature detector 164 for measuring the temperature of the battery 150, and a state of charge (SoC) calculator 165 for calculating an SoC of the battery 150 based on the voltage/current/temperature of the battery 150.

The fuel tank 170 may store fuel (e.g., gasoline, diesel) required for driving of the vehicle 100.

The vehicle driving controller 180 may control components related to driving of the vehicle 100, such as engine, motor, steering system, braking system, and the like.

The vehicle driving controller 180 may include a communication device 181, an information device 182, and a controller 183.

The communication device 181 may communicate with various electronic devices inside the vehicle 100 through the vehicle communication network 110. For example, the communication device 181 may receive a driving control signal for autonomous driving of the vehicle 100 from the autonomous driving controller 130.

The information device 182 may store property parameters of engine, property parameters of motor, property parameters of steering system, and property parameters of braking system to perform fine control on the engine, motor, steering system, and braking system included in the vehicle 100.

The controller 183 may control operation of the engine, motor, steering system, and braking system based on the driving control signal received from the autonomous driving controller 130 through the communication unit 181 and the property parameters of engine, motor, steering system, and braking system stored in the information device 182.

For example, the controller 183 may control the engine or the motor to move the vehicle 100 forward, the steering system to steer the vehicle 100 to a changed driving direction, the braking system to stop the vehicle 100.

As described above, the vehicle 100 may take a user or passenger for a ride at a starting point and autonomously drive to a destination, based on vehicle allocation information received from the vehicle allocation server 10.

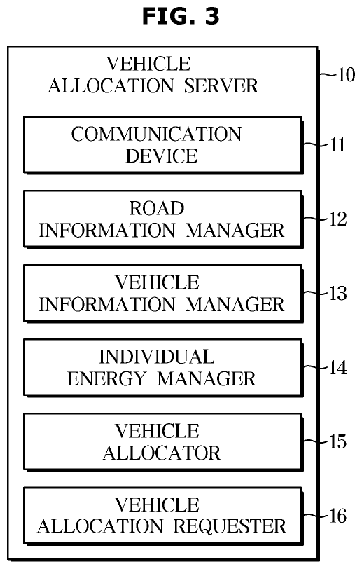

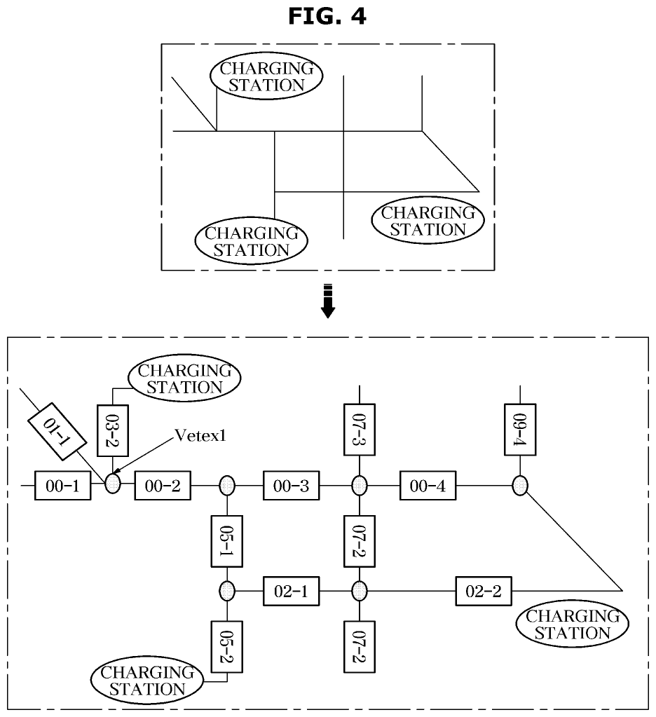

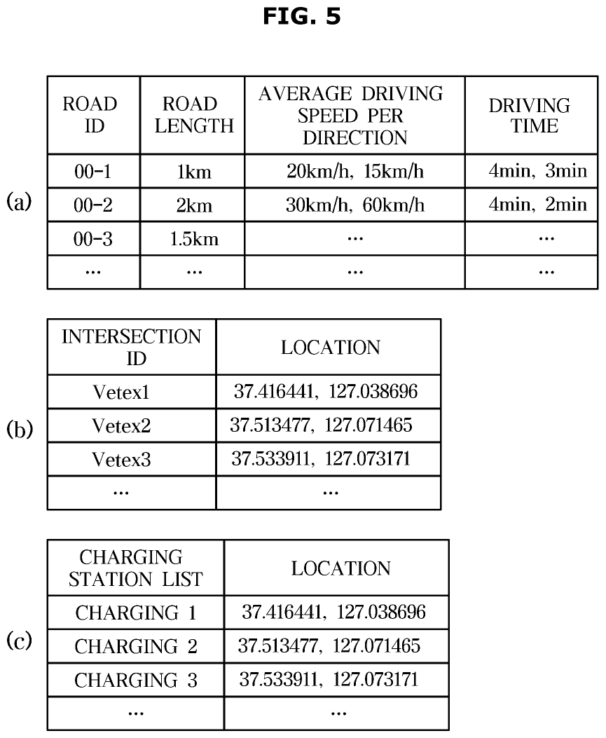

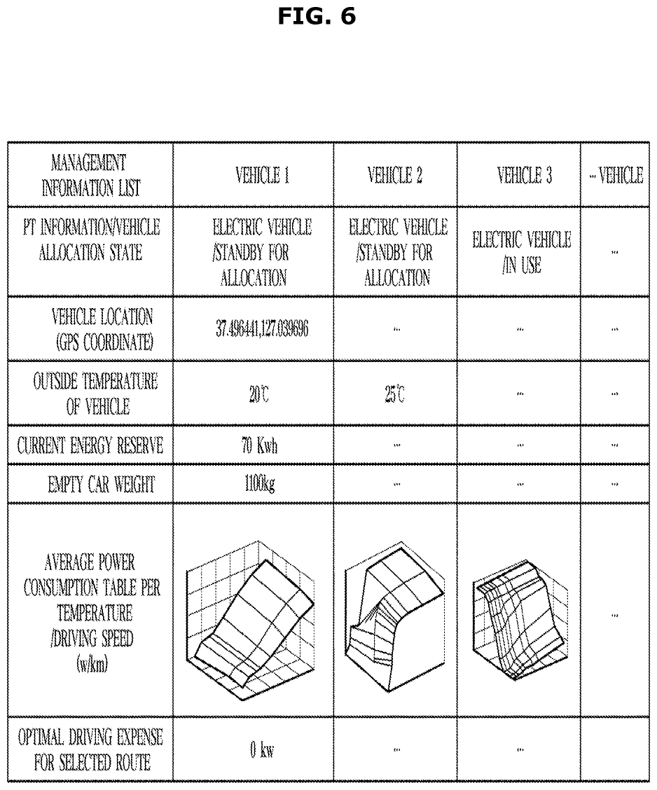

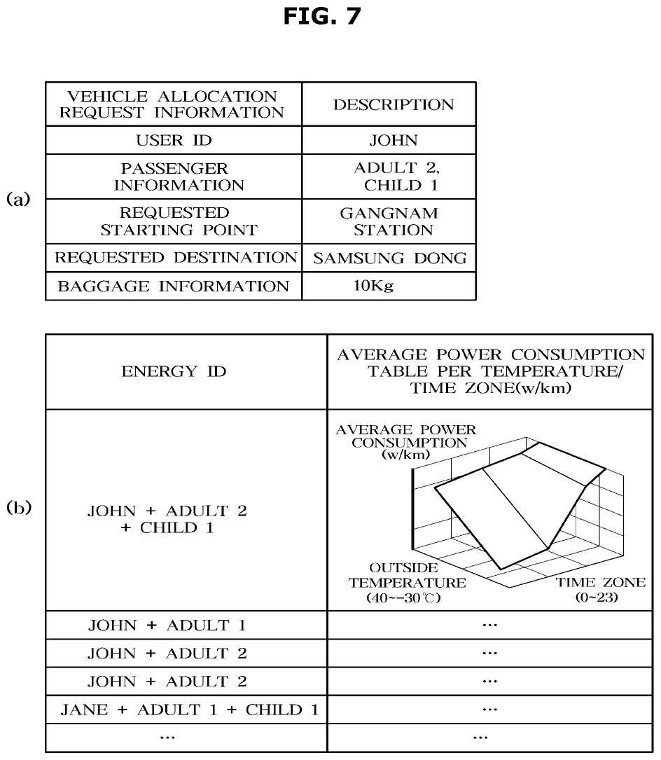

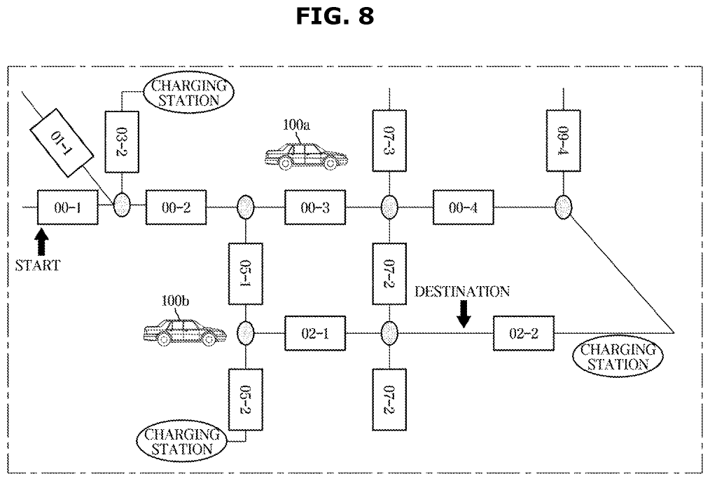

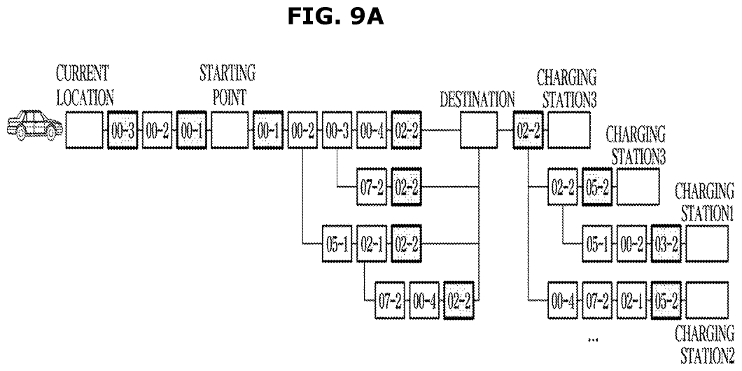

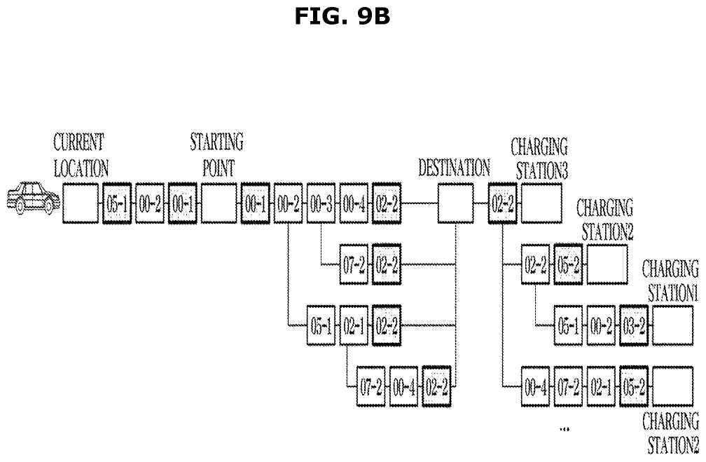

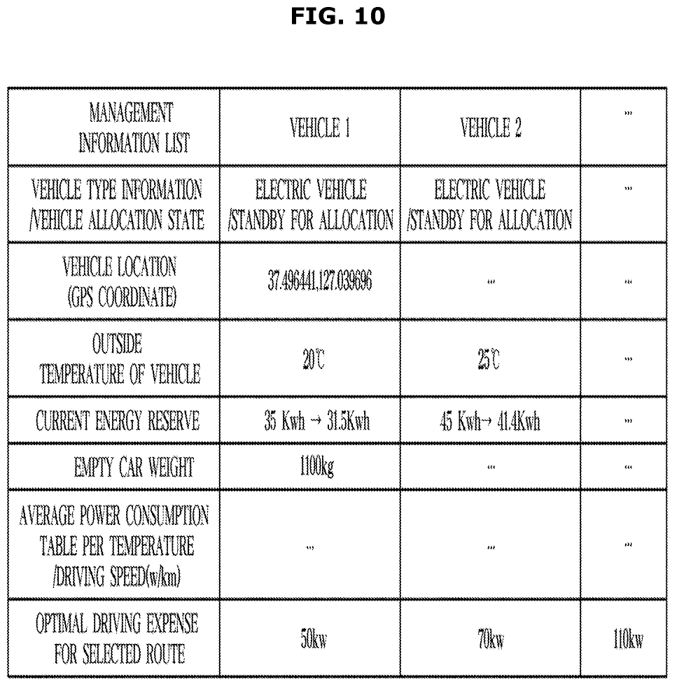

FIG. 3 shows a configuration of a vehicle allocation server included in a vehicle allocation system, in one form of the present disclosure. FIG. 4 shows an example of map information stored in a vehicle allocation server, in one form of the present disclosure. FIG. 5 shows an example of road information and traffic information stored in a vehicle allocation server, in one form of the present disclosure. FIG. 6 shows an example of vehicle information stored in a vehicle allocation server, in one form of the present disclosure. FIG. 7 shows an example of user energy information stored in a vehicle allocation server, in one form of the present disclosure. FIG. 8 shows an example of a vehicle allocation request sent to a vehicle allocation server, in one form of the present disclosure. FIGS. 9A and 9B show traveling paths of vehicles according to a vehicle allocation request sent to a vehicle allocation server, in one form of the present disclosure. FIG. 10 shows optimal driving expenses of vehicles according to a vehicle allocation request sent to a vehicle allocation server, in one form of the present disclosure;

The vehicle allocation server 10 may manage the plurality of vehicles 100a and 100b in response to a vehicle allocation request made by a user and allocate one of the plurality of vehicles 100a and 100b to the user.

Referring to FIGS. 3 to 10, the vehicle allocation server 10 includes a communication device 11, a road information manager 12, a vehicle information manager 13, an individual energy manager 14, a vehicle allocator 15, and a vehicle allocation requester 16.

The communication device 11 may communicate with the plurality of vehicles 100a and 100b, the traffic information server 20, and the user device 30.

For example, the communication device 11 may wirelessly communicate with the plurality of vehicles 100a and 100b and the user device 30. The communication device 11 may communicate with the plurality of vehicles 100a and 100b and the user device 30 in a 2G communication scheme such as TDMA and CDMA, a 3D communication scheme such as WCDMA, CDMA2000 and WiMAX, and/or a 4G communication scheme such as LTE, Wibro evolution. Furthermore, the communication device 11 may communicate with the plurality of vehicles 100a and 100b and the user device 30 in a 5G communication scheme.

The communication device 11 may also communicate with the traffic information sever 20 in a wired communication scheme.

The road information manager 12 may mange road information required for driving.

For example, the road information manager 12 may mange road information using map information.

The road information manager 12 may issue road identification (ID) for each road based on an intersection where three or more roads join, as shown in FIG. 4. For example, in FIG. 4, road 02-2 is issued single road ID because it joins two roads although a vertical road and a horizontal road are connected to the road.

The road information manager 12 may extract actual length of a road issued a road ID.

The road information manager 12 may obtain an average vehicle driving speed from the traffic information server 20.

As described above, the traffic information server 20 may receive position and driving information (e.g., driving speed information) of vehicles from the vehicles, and calculate an average driving speed of the vehicles on each road based on the position and driving speed of the vehicles. Furthermore, the traffic information server 20 may send the average vehicle driving speed on each road to the vehicle allocation server 10.

When a unit road managed by the road information manager 12 is different from that of the traffic information server 20, the road information manager 12 may adjust the average driving speed received from the traffic information server 20. For example, when the unit road managed by the road information manager 12 is smaller than that of the traffic information server 20, the road information manager 12 may apply the average driving speed received from the traffic information server 20 to each road as it is. When the unit road managed by the road information manager 12 is larger than that of the traffic information server 20, the road information manager 20 may adjust the average driving speed received from the traffic information server 20 in proportion to the road length and apply the adjusted result to each road.

The road information manager 12 may update the average vehicle driving speed on each road in real time.

The road information manager 12 may calculate driving time on each road based on the actual length of the road and the average vehicle driving speed on the road. The road information manager 12 may update the driving time on each road in real time.

As shown in (a) of FIG. 5, the road information manager 12 may store a traffic information table including road IDs, road lengths corresponding to the road IDs, average driving speeds on the roads with the road IDs, and driving time on the roads with the road IDs.

The road information manager 12 may also issue an intersection ID for each intersection, and as shown in (b) of FIG. 5, store an intersection information table including intersection IDs and position information of the intersections issued the intersection IDs.

The road information manger 12 may also store a charging station information table including charging station IDs or gas station IDs (e.g., names) and position information of the charging stations or gas stations, as shown in (c) of FIG. 5.

The vehicle information manager 13 may obtain vehicle type information, a vehicle allocation state, a vehicle position, outside temperature of the vehicle, an energy reserve level of the vehicle, and a weight of the vehicle from the vehicle driving controller 180, the autonomous driving controller 130, and the navigation 140 of every vehicle registered in the vehicle allocation server 10. Furthermore, the vehicle information manager 13 may create a vehicle information table from the vehicle type information, vehicle allocation state, position, outside temperature, energy reserve level, and weight of each vehicle, as shown in FIG. 6.

The vehicle information manager 13 may delete information of a vehicle from the vehicle information table when the vehicle breaks down or drifts away, and may add information of a vehicle when the vehicle is added.

The vehicle information table may further include average power consumption per temperature/vehicle speed. The average power consumption per temperature/vehicle speed may be provided in graphs as shown in FIG. 6 or in a separate table.

The vehicle information table may further include predefined average power consumption per temperature/vehicle speed for each vehicle type. To reduce gaps during driving of the vehicle 100, the vehicle driving controller 180 of the vehicle 100 may calculate power consumption of the vehicle 100 per temperature and driving speed except the power consumption of utility loads, and the vehicle 100 may send the power consumption per temperature and vehicle speed obtained during the driving to the vehicle allocation server 10.

The vehicle information manager 13 may update average power consumption per temperature/vehicle speed in real time based on the power consumption per temperature and vehicle speed received from the vehicle 100.

When the user's vehicle allocation request is received from the user device 30, the individual energy manager 14 may obtain boarding information input with the user's vehicle allocation request. The boarding information may include a user ID, passenger information, a starting point, a destination and baggage information, as shown in (a) of FIG. 7.

The individual energy manager 14 may calculate an extra weight based on the passenger information and baggage information included in the user information, and manage user energy information including a user energy ID based on the user ID, as shown in (b) of FIG. 7. The user energy information may include the user energy ID and user's average power consumption per temperature/time zone. The user's average power consumption per temperature/time zone may be provided in graphs as shown in (b) of FIG. 7 or in a separate table.

Even for the same user ID, energy use patterns become different for different passenger information received from the user device 30 from the existing passenger information, in which case a new user energy ID and the user's average power consumption per temperature/time zone may be created.

When the passenger information received from the user device 30 is identical to the existing passenger information, the individual energy manager 14 may use the registered user's average power consumption per temperature/time zone.

The vehicle driving controller 180 of the vehicle 100 may send the vehicle allocation server 10 information about non-driving consumption (e.g., consumption for utility loads) of battery or fuel consumption of the vehicle 100 except consumption for driving the vehicle 100 when the vehicle 100 is driven with all the passengers.

The individual energy manager 14 may receive the information about the non-driving consumption from the vehicle 100 and update the user's average power consumption per temperature/time zone of the user information table based on the received information about non-driving consumption.

The vehicle allocator 15 may select a vehicle based on the traffic information, vehicle information, and user information in response to the vehicle allocation request received from the user device 30, and allocate the selected vehicle to the user.

The vehicle allocator 15 may calculate routes for the plurality of vehicles 100a and 100b to travel to a starting point, travel to a destination from the starting point, and then travel from the destination to a charging station.

For example, the user (passenger) may make a vehicle allocation request with road 00-1 as a starting point and road 02-2 as a destination as shown in FIG. 8. In FIG. 8, vehicle 1 100a is located on road 00-3 and vehicle 2 100b is located on road 05-1.

The vehicle allocator 15 may calculate a plurality of traveling routes for the vehicles 100a and 100b to travel, based on the user's vehicle allocation request and the locations of the vehicles 100a and 100b.

Referring to FIG. 9A, vehicle 1 100a may travel to the starting point via road 00-3, road 00-2, and road 00-1, travel to the destination via road 00-2, road 00-3, road 00-4, and road 02-2, and travel to charging station 3 via road 02-2. Furthermore, vehicle 1 100a may travel to charging station 2 or charging station 1 via the starting point and the destination along another route.

Referring to FIG. 9B, vehicle 2 100b may travel to the starting point via road 05-1, road 00-2, and road 00-1, travel to the destination via road 00-2, road 00-3, road 00-4, and road 02-2, and travel to charging station 3 via road 02-2.

The vehicle allocator 15 may calculate a driving distance for each of the plurality of traveling routes.

The vehicle allocator 15 may also calculate energy consumption for driving on each of the plurality of traveling routes.

For example, the vehicle allocator 15 may calculate the energy consumption for driving on a traveling route as in the following equation (1):

energy consumption=driving distance X (average power consumption per temperature/vehicle speed+average power consumption per temperature/time zone) (1)

The energy consumption may represent energy consumption for each of the plurality of traveling routes. The driving distance may represent a driving distance of each of the plurality of traveling routes. The average power consumption per temperature/vehicle speed may represent the average power consumption per temperature/vehicle speed shown in FIG. 6. The average power consumption per temperature/time zone may represent the average power consumption per temperature/time zone shown in FIG. 7.

To reflect an extra weight in the individual energy manager 14 onto the energy consumption, the vehicle allocator 15 may adjust current energy reserve levels of the vehicles 100a and 100b based on fuel/electricity efficiency drop characteristics of the vehicle depending on the weight, as shown in FIG. 10.

The fuel/electricity efficiency drop characteristics of the vehicle may be calculated as inertial resistance based on a vehicle weight and the extra weight, which is expressed in the following equation (2):

Ri=(W+ΔW)*A/G (2)

where Ri denotes the inertial resistance, W denotes the vehicle weight, ΔW denotes the extra weight, A denotes acceleration of the vehicle, and G denotes gravitational acceleration.

The vehicle allocator 15 may calculate energy consumption for each of the vehicles to travel from the starting point to the destination designated by the user, and as shown in FIG. 10, update optimal driving expense for a selected route in the vehicle information table.

The vehicle allocator 15 may allocate the user one of the vehicles listed in the vehicle information table, which has minimum optimal driving expense. For example, as shown in FIG. 10, the vehicle allocator 15 may allocate vehicle 1 100a to the user because the vehicle 1 100a has the minimum optimal driving expense.

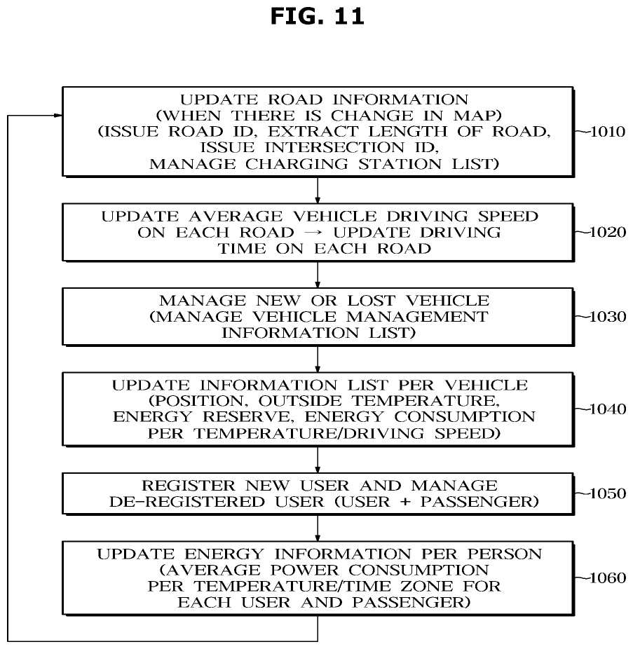

FIG. 11 is a flowchart illustrating information management method of a vehicle allocation server, in one form of the present disclosure.

The vehicle allocation server 10 updates road information in response to a change in map, in 1010.

The road information manager 12 of the vehicle allocation server 10 may issue a road ID to a road based on the map information, extract the length of the road, issue an intersection ID to an intersection, and manage e.g., locations of charging stations.

The vehicle allocation server 10 updates average vehicle speed per road and driving time per road, in 1020.

The road information manager 12 may obtain an average vehicle driving speed from the traffic information server 20. Furthermore, the road information manager 12 may calculate driving time on each road based on the actual length of the road and the average vehicle driving speed on the road.

The vehicle allocation server 10 manages new and lost vehicles, in 1030.

The vehicle allocation manager 13 may manage all the vehicles registered in the vehicle allocation server 10.

For example, the vehicle information manager 13 may delete information of a vehicle from the vehicle information table when the vehicle breaks down or drifts away, and may add information of a vehicle when the vehicle is added.

The vehicle allocation server 10 updates information for each vehicle, in 1040.

The vehicle information manager 13 of the vehicle allocation server 10 may create a vehicle information table from the vehicle type information, vehicle allocation state, position, outside temperature, energy reserve level, and weight of each vehicle.

The vehicle information manager 13 may receive power consumption per temperature and vehicle speed from the vehicle 100 and update it. Furthermore, the vehicle information manager 13 may update average power consumption per temperature/vehicle speed in real time based on the power consumption per temperature and vehicle speed received from the vehicle 100.

The vehicle allocation server 10 manages user information, in 1050.

The individual energy manager 14 of the vehicle allocation server 10 may register a new user, and may deregister a user who signs out.

In addition, the individual energy manager 14 may issue a user ID to each of the users, and manage user energy information including a user energy ID based on the user ID.

The vehicle allocation server 10 updates the user energy information, in 1060.

The vehicle driving controller 180 of the vehicle 100 may send the vehicle allocation server 10 information about non-driving consumption (e.g., consumption for utility loads) of battery or fuel consumption of the vehicle 100 except consumption for driving the vehicle 100 when the vehicle 100 is driven with all the passengers.

The individual energy manager 14 may receive the information about the non-driving consumption from the vehicle 100 and update the user's average power consumption per temperature/time zone of the user information table based on the received information about non-driving consumption.

As described above, the vehicle allocation server 10 may update the road information, the vehicle information, and the user information.

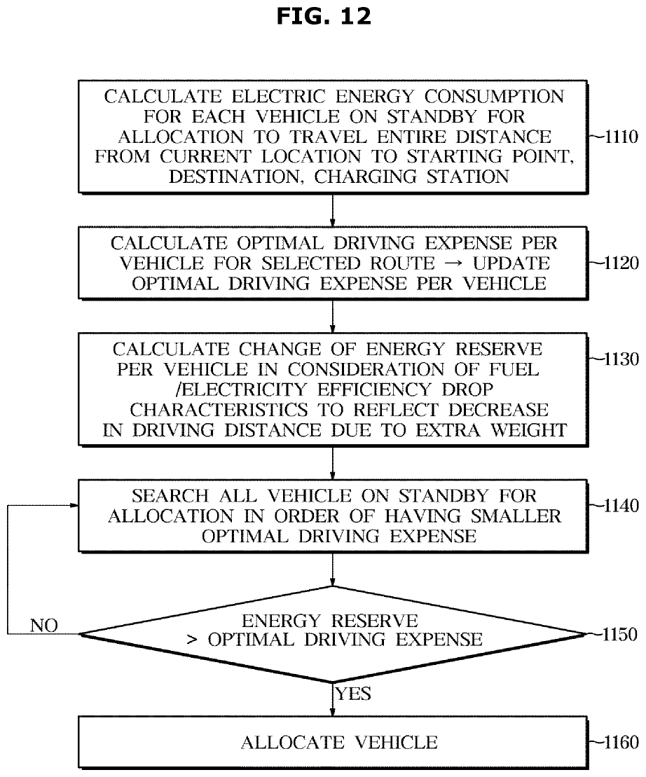

FIG. 12 is a flowchart illustrating a vehicle allocation method, in one form of the present disclosure.

The vehicle allocation server 10 calculates electric energy consumption for each vehicle on standby for allocation to travel the entire distance from the current location to a starting point, a destination, and a charging station, in 1110.

The user's vehicle allocation request may include passenger information, information about starting point and destination, and baggage information.

The vehicle allocator 15 may calculate a plurality of traveling routes for the vehicles 100a and 100b to travel, based on the user's vehicle allocation request and the locations of the vehicles 100a and 100b.

The vehicle allocator 15 may also calculate a driving distance on each of the plurality of traveling routes and energy consumption for driving on each of the plurality of traveling routes.

The vehicle allocation server 10 calculates an optimal driving expense for a selected route of each vehicle, in 1120.

The vehicle allocator 15 may calculate energy consumption for each of the vehicles to travel from the starting point to the destination designated by the user, and may update the optimal driving expense for a selected route in the vehicle information table.

The vehicle allocation server 10 adjusts the energy reserve level of each vehicle in consideration of fuel/electricity efficiency drop characteristics to reflect a possible decrease in driving speed due to extra weight, in 1130.

To reflect extra weight in the individual energy manager 14 onto the energy consumption, the vehicle allocator 15 may adjust current energy reserve levels of the vehicles 100a and 100b based on fuel/electricity efficiency drop characteristics of the vehicle depending on the weight. For example, the fuel/electricity efficiency drop characteristics of the vehicle may be calculated as inertial resistance based on vehicle weight and the extra weight, which is expressed in the equation (2).

The vehicle allocation server 10 searches all the vehicles on standby for allocation in order of having smaller driving expense, in 1140.

The vehicle allocator 15 may select one of the vehicles listed in the vehicle information table, which has minimum optimal driving expense.

The vehicle allocation server 10 determines whether an energy reserve level of the selected vehicle is higher than the optimal driving expense, in 1150.

When it is determined that the energy reserve level of the selected vehicle is not higher than the optimal driving expense (no in 1150), the vehicle allocation server 10 re-searches all the vehicles on standby for allocation in order of having smaller optimal driving expenses.

When the energy reserve level of the selected vehicle is higher than the optimal driving expense (yes in 1150), the vehicle allocation server 10 allocates the selected vehicle to the user, in 1160.

The vehicle allocator 15 may allocate the user one of the vehicles listed in the vehicle information table, which has minimum optimal driving expense.

As described above, the vehicle allocation server 10 may calculate optimal driving expense for each vehicle, and allocate a vehicle having the smallest optimal driving expense to the user.

In some forms of the present disclosure, an autonomous vehicle allocation method, server, and system may be provided, which allocates autonomous vehicles by reflecting energy use characteristics of each person for efficient management and operation of shared vehicles, such as unmanned taxis with an autonomous driving system applied thereto.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle allocation method comprising:
receiving, from a user device, a vehicle allocation request including a starting point and a destination;
calculating energy consumption of each vehicle of a plurality of vehicles to travel a distance from a current location to the starting point, the destination, and a charging station, in response to the vehicle allocation request;
selecting a vehicle having a minimum energy consumption among the plurality of vehicles; and
sending, to the vehicle, a driving command to move to the starting point.

2. The vehicle allocation method of claim 1, wherein calculating the energy consumption of the each vehicle of the plurality of vehicles comprises:
updating a map; and
calculating average driving speed and average driving time on each road included in the map based on traffic information received from a traffic information server.

3. The vehicle allocation method of claim 2, wherein calculating the energy consumption of the each vehicle of the plurality of vehicles comprises:
obtaining vehicle information including a current location of the vehicle, energy reserve of the vehicle, and a first power consumption of the vehicle, wherein the first power consumption of the vehicle is a power consumption of the vehicle corresponding to temperature of the vehicle and a driving speed of the vehicle.

4. The vehicle allocation method of claim 3, wherein calculating the energy consumption of the each vehicle of the plurality of vehicles comprises:
obtaining user information including a second power consumption of the vehicle, wherein the second power consumption of the vehicle is the power consumption of the vehicle corresponding to temperature of a user and a time zone of the user.

5. The vehicle allocation method of claim 4, wherein calculating the energy consumption of the each vehicle of the plurality of vehicles comprises:
calculating the energy consumption of the each vehicle of the plurality of vehicles by multiplying a combined power consumption with the distance, wherein the combined power consumption is an addition of the first power consumption of the vehicle and the second power consumption of the vehicle.

6. The vehicle allocation method of claim 4, wherein receiving the vehicle allocation request further comprises:
weighing baggage; and
adjusting energy reserve of the selected vehicle based on the weighed baggage.

7. The vehicle allocation method of claim 1, wherein the method further comprises:
when the energy reserve of the selected vehicle is less than an energy consumption of the selected vehicle corresponding to the distance, selecting a vehicle with a second least energy consumption among the plurality of vehicles.

8. A vehicle allocation server comprising:
a communication device configured to:
receive, from a user device, a vehicle allocation request including a starting point and a destination; and
send, to the vehicle, a driving command to move to the starting point; and
a vehicle allocator configured to:
calculate energy consumption of each vehicle of a plurality of vehicles to travel a distance from a current location to the starting point, the destination, and a charging station, in response to the vehicle allocation request, and
select a vehicle having a minimum energy consumption among the plurality of vehicles.

9. The vehicle allocation server of claim 8, wherein the server further comprises:
a traffic information manager configured to:
update a map; and
calculate average driving speed and average driving time on each road included in the map based on traffic information received from a traffic information server.

10. The vehicle allocation server of claim 9, wherein the server further comprises:
a vehicle information manager configured to obtain vehicle information including a current location of the vehicle, energy reserve of the vehicle, and a first power consumption of the vehicle, wherein the first power consumption of the vehicle is a power consumption of the vehicle corresponding to temperature of the vehicle and a driving speed of the vehicle.

11. The vehicle allocation server of claim 10, wherein the server further comprises:
a user information manager configured to obtain user information including a second power consumption of the vehicle, wherein the second power consumption of the vehicle is the power consumption of the vehicle corresponding to temperature of a user and a time zone of the user.

12. The vehicle allocation server of claim 11, wherein the vehicle allocator is configured to calculate the energy consumption of the each vehicle of the plurality of vehicles by multiplying a combined power consumption with the distance, wherein the combined power consumption is an addition of the first power consumption of the vehicle and the second power consumption of the vehicle.

13. The vehicle allocation server of claim 8, wherein:
the communication device is further configured to weigh baggage, and
the vehicle information manager configured to adjust energy reserve of the selected vehicle based on the weighed baggage.

14. The vehicle allocation server of claim 8, wherein the vehicle allocator is configured to, when the energy reserve of the selected vehicle is less than an energy consumption of the selected vehicle corresponding to the distance, select a vehicle with a second least energy consumption among the plurality of vehicles.

15. A vehicle allocation system comprising:
a plurality of vehicles;
a user device configured to receive a vehicle allocation request including a starting point and a destination from a user; and
a vehicle allocation server configured to:
calculate energy consumption of each vehicle of a plurality of vehicles to travel a distance from a current location to the starting point, the destination, and a charging station, in response to the vehicle allocation request;
select a vehicle having a minimum energy consumption among the plurality of vehicles; and
send, to the vehicle, a driving command to move to the starting point.

16. The vehicle allocation system of claim 15, wherein the vehicle allocation server is configured to:
update a map; and
calculate average driving speed and average driving time on each road included in the map based on traffic information received from a traffic information server.

17. The vehicle allocation system of claim 16, wherein the vehicle allocation server is configured to obtain vehicle information including a current location of the vehicle, energy reserve of the vehicle, and a first power consumption of the vehicle, wherein the first power consumption of the vehicle is a power consumption of the vehicle corresponding to temperature of the vehicle and a driving speed of the vehicle.

18. The vehicle allocation system of claim 17, wherein the vehicle allocation server is configured to obtain user information including a second power consumption of the vehicle, wherein the second power consumption of the vehicle is the power consumption of the vehicle corresponding to temperature of a user and a time zone of the user.

19. The vehicle allocation system of claim 18, wherein the vehicle allocation server is configured to calculate the energy consumption of the each vehicle of the plurality of vehicles by multiplying a combined power consumption with the distance, wherein the combined power consumption is an addition of the first power consumption of the vehicle and the second power consumption of the vehicle.

20. The vehicle allocation system of claim 16, wherein the vehicle allocation server is configured to, when the energy reserve of the selected vehicle is less than an energy consumption of the selected vehicle corresponding to the distance, select a vehicle with a second least energy consumption among the plurality of vehicles.
